(19) United States
(12) Patent Application Publication
(10) Pub. No.: US 2011/0311887 A1
(43) Pub. Date: Dec. 22, 2011

(54) MICROBIAL DESALINATION CELLS

(75) Inventor: Zhen He, Bayside, WI (US)

(73) Assignee: UWM RESEARCH FOUNDATION, INC., Milwaukee, WI (US)

(21) Appl. No.: 13/160,929

(22) Filed: Jun. 15, 2011

Related U.S. Application Data
(60) Provisional application No. 61/355,438, filed on Jun. 16, 2010.

(51) Int. Cl. H01M 8/16; C02F 3/00; C02F 103/08

(52) U.S. Cl. 429/401; 210/205; 210/200; 210/601; 210/614

(57) ABSTRACT

A microbial desalination cell includes an anode, a cathode, a saline solution chamber and a cathode rinsing assembly. The anode is at least partially positioned within an anode chamber for containing an aqueous reaction mixture including one or more organic compounds and one or more bacteria for oxidizing the organic compounds. The cathode is directly exposed to air. The saline solution chamber is positioned between the anode and the cathode, and is separated from the anode by an anion exchange material and from the cathode by a cation exchange material. The cathode rinsing assembly is for rinsing the cathode with a catholyte.

### REFERENCE TO RELATED APPLICATION

This application claims the benefit of U.S. Provisional Patent Application No. 61/355,438, filed Jun. 16, 2010, the content of which is incorporated herein by reference in its entirety.

### BACKGROUND

The lack of adequate quantities of fresh water poses a significant global challenge. About 97% of the Earth's water is seawater, which is non-potable and cannot be used for agricultural irrigation. Improved methods and systems for desalinating water may be critical for producing fresh water, especially in areas where seawater is abundant, but fresh water is not. Generally, salts can be removed from water using thermal and/or membrane desalination systems, which each require substantial energy. The primary source of energy for powering such desalination systems currently comes from fossil fuels, which are expensive, are non-renewable, and have a substantial environmental impact. Renewable energies, such as solar, wind, hydroelectric and geothermal energies, may be used to drive desalination processes. However, at the current stage, desalination powered by renewable energy costs more than the methods powered by conventional energy sources, although environmental benefits may balance those costs.

Bioenergy from organic wastes represents a promising energy source that may be used to drive desalination. For example, biogases produced during anaerobic digestion of organic compounds (e.g., during wastewater treatment) can be harvested and converted to electricity for driving thermal and/or membrane desalination systems. Alternatively or additionally, electricity may be harvested directly during microbial metabolism of organic matter using a microbial fuel cell (MFC). In an MFC, electrons and protons are produced at an anode during microbial metabolism of organic compounds. The electrons thereafter flow through a wire to a cathode, where they reduce a terminal electron acceptor (e.g., oxygen). An electrical current is produced when the electrons flow between the two electrodes. Ion transport between the anode and cathode (e.g., through ion exchange membranes separating the anode and cathode) is needed to maintain proper charge balance and facilitate the generation of electricity.

MFCs can be modified so as to be able to desalinate water concurrently with the treatment of organic wastes, and the production of electricity. Specifically, MFCs can be modified to include a saline solution chamber positioned between the anode and cathode and containing an aqueous saline solution that includes cations and anions. When electricity is generated in such a modified MFC, the cations in the saline solution move through a cation exchange membrane (CEM) to or toward the cathode, while the anions in the saline solution move through an anion exchange membrane (AEM) to or toward the anode. This ion transport maintains the proper charge balance between the anode and cathode, while separating the cations and anions from the aqueous solution in the saline solution chamber, thereby desalinating the solution. These modified MFCs commonly are referred to as microbial desalination cells (MDCs).

Integrating wastewater treatment with desalination within MDCs allows bio-electricity produced from wastewater to be a driving force for desalination, and incorporates salt removal as a part of the energy-producing process. MDCs can be either used as a pre-desalination process before conventional desalination to reduce salinity and the amount of energy required by downstream processes, or used as a sole process for decentralized treatment.

### SUMMARY OF THE INVENTION

This disclosure provides microbial desalination cells (MDCs), and desalination processes. Some MDCs disclosed herein include an anode, an anode chamber, an anion exchange material, a cathode, a cation exchange material, a saline solution chamber and a cathode rinsing assembly. The anode is at least partially positioned within the anode chamber for containing an aqueous reaction mixture including one or more organic compounds and one or more bacteria for oxidizing the organic compounds. The cathode is directly exposed to air. The saline solution chamber is positioned between the anode and the cathode, and is separated from the anode by the anion exchange material and from the cathode by the cation exchange material. The cathode rinsing assembly is for rinsing the cathode with a catholyte.

In some embodiments, the cathode rinsing assembly includes a sprayer assembly, a reservoir, and/or a control assembly. The sprayer assembly may include at least one sprayer for spraying the catholyte onto the cathode, and a pump for delivering catholyte to the sprayer. The reservoir collects the catholyte after it has been used to rinse the cathode. The cathode rinsing assembly may include a control assembly for controlling the pH, the salt concentration or the pH and the salt concentration of the catholyte. In some embodiments, the catholyte is acidified water.

Some MDCs disclosed herein include a saline solution chamber having a fluid inlet positioned on or below a horizontal plane, and a fluid outlet positioned above the horizontal plane, where water flowing between the inlet and outlet flows substantially upwardly.

Optionally, the MDCs disclosed herein include a control system for selectively adjusting the amount of current and power produced by the MDC. Optionally, the MDCs are used as a part of a desalination system having a plurality of MDCs for large scale desalination processes.

Desalination processes according to embodiments of this disclosure include flowing a saline solution through a saline solution chamber of a MDC, where the saline solution chamber is positioned between an anode and a cathode, and is separated from the anode by an anion exchange material and from the cathode by a cation exchange material, and where the cathode is directly exposed to air, generating an electrical potential between the anode and the cathode, where at least a portion of the electrical potential is generated by bacteria disposed in electrical contact with the anode, and selectively rinsing the cathode with a catholyte.

In some embodiments, rinsing the cathode with a catholyte comprises spraying the catholyte onto the cathode with a sprayer, collecting the catholyte after it has been used to rinse the cathode, recirculating the catholyte, and/or controlling the pH, the salt concentration or the pH and the salt concentration of the catholyte.

### BRIEF DESCRIPTION OF THE DRAWINGS

FIG. 1 is a schematic illustration of an exemplary microbial desalination cell (MDC).

FIG. 2 is a schematic illustration of an exemplary desalination system.

FIG. 3 is a schematic illustration of aspects of an exemplary desalination system.

FIG. 4 is a pair of graphs showing the performance of an exemplary MDC during a startup period, where the top graph (A) shows current generation, total dissolved solids (TDS), and % TDS removal, and the bottom graph (B) shows the variation of pH in the effluents from the cathode, and from the salt solution and anode chambers.

FIG. 5 is a graph showing current generation and TDS removal of an exemplary MDC with a hydraulic retention time (HRT) period of 4 days.

FIG. 6 is a graph showing a polarization curve (i.e., the power density, current density and voltage) of an exemplary MDC at a HRT of 4 days, and a scan rate of 0.1 mV/s.

FIG. 7 is a pair of graphs showing the desalination performance of an exemplary MDC, where the top graph (A) shows the TDS reduction in salt solution and artificial seawater at different HRTs, and the bottom graph (B) shows the conductivity of the influents to the saline solution chamber and effluents from the saline solution chamber for both salt water and artificial seawater at different HRTs.

FIG. 8 is a pair of bar charts comparing the performance of an exemplary MDC having an open circuit to an exemplary MDC with a closed circuit (0.1Ω), where the top chart (A) shows the conductivity of salt solution and additional water flux through the saline solution chamber, and the bottom chart (B) shows an estimate of different contributions to the % reduction in TDS.

FIG. 9 is a graph showing polarization curves of an exemplary MDC treating both salt solution and artificial seawater at a HRT of two days, and a scan rate of 0.1 mV/s.

### DETAILED DESCRIPTION

This disclosure provides microbial desalination cells (MDCs) and methods for their use in desalination of saline materials.

The term “saline solution,” as used herein, refers to aqueous mixtures including dissolved salts. Saline solutions include, but are not limited to, brackish water, saline water, and brine.

The term “fresh water,” as used herein, refers to water having less than 0.5 parts per thousand dissolved salts.

The term “brackish water,” as used herein, refers to water having 0.5-30 parts per thousand dissolved salts.

The term “saline water,” as used herein, refers to water having greater than 30-50 parts per thousand dissolved salts.

The term “brine,” as used herein, refers to water having greater than 50 parts per thousand dissolved salts.

The term “wastewater” as used herein refers to water containing organic material, particularly aqueous waste disposed from domestic, municipal, commercial, industrial and agricultural uses. For example, wastewater includes human and other animal biological wastes, and industrial wastes such as food processing wastewater.

The term “desalination,” as used herein, refers to the separation of dissolved salts from saline materials. For example, desalination refers to separation of halides, carbonates, phosphates and sulfates of sodium, potassium, calcium, lithium, magnesium, zinc or copper from aqueous mixtures. The term desalination encompasses both complete and partial removal of dissolved mineral salts from aqueous mixtures. The term “desalinated water,” as used herein, refers to water that has undergone a desalination process.

The term “providing,” as used herein, refers to any means of obtaining a subject item, such as an MDC or one or more components thereof, from any source, including, but not limited to, making the item or receiving the item from another.

Microbial Desalination Cells Generally

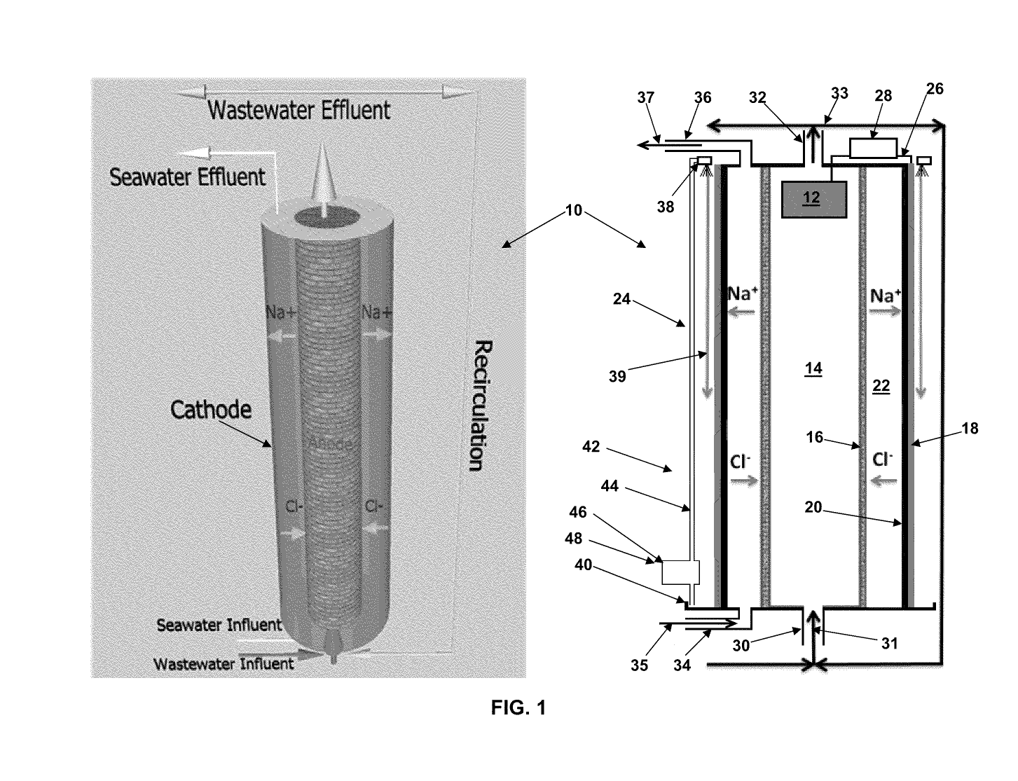

FIG. 1 is a schematic illustration of an exemplary MDC 10, which may include an anode 12, an anode chamber 14, an anion exchange material 16, a cathode 18, a cation exchange material 20, a saline solution chamber 22, and a cathode rinsing assembly 24. The exemplary MDC of FIG. 1 includes two chambers (the anode chamber 14 and the saline solution chamber 22) defined by the anion and cation exchange materials, but does not include a cathode chamber. Specifically, the anion exchange material at least partially defines an outer wall of the anode chamber and an inner wall of the saline solution chamber, and the cation exchange material at least partially surrounds the anion exchange material and defines an outer wall of the saline solution chamber. As such, the saline solution chamber at least partially surrounds the anode chamber. The anode is at least partially positioned within the anode chamber, and the cathode is positioned adjacent to and in direct contact with the outer surface of the cation exchange material and is directly exposed to air. A conduit 26 for electrons connects the anode and cathode and may be coupled to a power source or load 28. The anode chamber includes an inlet 30 for receiving influent fluid 31, including, but not limited to wastewater (e.g., municipal, industrial or agricultural wastewater, etc.), effluent 33 discharged from the anode chamber, and/or any other aqueous solutions comprising one or more organic compounds that may be oxidized bacteria within the anode chamber. The anode chamber also includes an outlet 32 for discharging effluent fluids 33, including, but not limited to, treated aqueous solutions and/or gases produced during bacterial oxidation of organic compounds within an anode chamber (e.g., hydrogen, carbon dioxide, methane, etc.). The saline solution chamber is positioned between the anode and the cathode, and is separated from the anode by the anion exchange material and from the cathode by the cation exchange material. The saline solution chamber may include an inlet 34 for receiving influent fluids 35, including, but not limited to saline solutions (e.g., brackish water, saline water, brine, etc.), and naturally occurring or artificially produced seawater. The saline solution chamber also may include an outlet 36 for discharging effluent fluids 37, including, but not limited to, desalinated water and/or any gases that may enter into the salt solution chamber. The cathode rinsing assembly is adapted to rinse the cathode with a catholyte, such as to remove salts and other byproducts, and to provide protons for the redox reactions occurring at the cathode. As discussed in more detail below, the catholyte may be acidified water, buffered water (e.g., phosphate buffers, bicarbonate buffers, etc.) or special solutions containing electron acceptors (e.g., oxygen, ferricyanide, iron (III), manganese, etc.). The catholyte can function as a medium, with a modified operation (e.g., apply a potential to the MDC), for production of valuable chemicals, such as hydrogen, hydrogen peroxide, methane and caustic soda.

It should be noted that the chambers of the MDC of FIG. 1 are defined entirely by the ion exchange materials. In other words, the sides of the chambers are constructed of the ion exchange materials themselves, and are not constructed of glass, metal, plastic or some other rigid material. This makes the MDCs inexpensive and easy to construct, use and replace.

However, it should be appreciated that MDCs may have many different configurations, including those that are significantly different from the one shown in FIG. 1. Some MDCs may include more than two chambers, including a salt solution chamber disposed between both an anode chamber and a cathode chamber, where the salt solution chamber is separated from the anode chamber by an anion exchange material and from the cathode chamber by a cation exchange material. For example, the MDC shown in FIG. 1 may be modified to further include an exterior wall (not shown) surrounding the cation exchange material, such that the cation exchange material defines the inner wall of a cathode chamber, and the exterior wall of the MDC defines the outer wall of the cathode chamber. In such embodiments, the cathode chamber may be filled with air or other gases (e.g., oxygen, ozone, nitrous oxide, or any other suitable electron acceptor), and/or with any suitable liquid catholyte, depending on the desired function. The exterior wall may be formed of glass, metal, plastic, or any other suitable material. Other MDCs may have a reverse setup from the one shown in FIG. 1, including a cation exchange material at least partially defining the outer wall of a cathode chamber and the inner wall of a saline solution chamber, an anion exchange material at least partially surrounding the cation exchange material and defining the outer wall of the saline solution chamber and the inner wall of an anode chamber, and an exterior wall defining the outer wall of the anode chamber. Yet other MDCs may include an anode chamber and cathode chamber that do not surround the salt solution chamber or each other, but instead are disposed adjacent to the salt solution chamber and are either parallel or transverse to one another. Some MDCs may include multiple anode chambers, multiple salt solution chambers and/or multiple cathode chambers, as discussed in more detail below. The anion and cation exchange materials, as well as the chamber walls that they define, may be any suitable shape consistent with their functions. For example, the anion and/or cation exchange materials may be cylindrical, or tubular, as shown in FIG. 1, such that one or more of the chambers are cylindrical. Alternatively or additionally, the anion and/or cation exchange materials may be rectangular, square, elliptical, or any other suitable shape. Finally, the volumes of the chambers defined by the ion exchange materials can be varied to suit the specific needs for the source and product water that depend on the extent of desalination, organic loading and current densities.

In operation, an aqueous solution containing one or more organic compounds (e.g., wastewater influent 31) is delivered to and received by the anode chamber 14 via the inlet 30. The reaction mixture within the anode chamber includes one or more bacteria for oxidizing the organic compounds, which produces electrons and protons. The electrons are transferred to the anode 12, through the conductive conduit 26 to the cathode 24, where the electrons react with oxygen to form water. This transport of electrons creates a charge differential between the anode and cathode. In the meantime, saline solution (e.g. seawater influent 35) is delivered to and received by the saline solution chamber 22 via inlet 34. Anions present in the saline solution (e.g., Cl⁻, among others) pass through the anion exchange membrane to the anode chamber 14, whereas cations present in the saline solution (e.g., Na⁺, among others) pass through the cation exchange membrane to the cathode 18, thereby desalinating the fluid within the saline solution chamber.

In some embodiments, the MDC may be an upflow microbial desalination cell (UMDC). Specifically, as shown in FIG. 1, the inlet 30 may be positioned at the bottom of the anode chamber 14 and the outlet 32 may be positioned at the top of the anode chamber. Similarly, the inlet 34 may be positioned at the bottom of the saline solution chamber 22 and the outlet 32 may be positioned at the top of the saline solution chamber. Such an upflow design provides numerous benefits over designs that lack an upflow design. For example, the upflow design facilitates mixing of fluids within the respective chambers due to turbulent diffusion. This mixing inhibits the formation of Nernst diffusion layers around the anode and/or concentration gradients within the anode and salt solution compartments. The upflow design also allows for easier collection of gases produced during microbial degradation. Finally, providing an upflow design for the anode chamber helps ensure that the microbes within the anode chamber remain in suspension. It should be appreciated that these same benefits may be achieved by upflow designs other than the one specifically shown in FIG. 1. For example, some MDCs may include an anode chamber or saline solution chamber comprising a fluid inlet positioned on or below a horizontal plane, and a fluid outlet positioned above the horizontal plane, where fluid flowing between the inlet and outlet flows substantially upwardly.

In some embodiments, the MDC may include flow obstacles within the anode chamber and/or salt solution chamber to create turbulence and enhance mixing of liquids within the chambers (i.e., to facilitate mass transport). Exemplary flow obstacles may include, but are not limited to, nets, spiral channels, spacers, springs, and the like.

As discussed above, some embodiments of MDCs, such as the exemplary MDC shown in FIG. 1, do not include a cathode chamber. In such embodiments, the cathode may be in direct contact with the cation exchange material, and may include a surface that is directly exposed to air. This may allow oxygen to freely come into contact with the cathode where it can be reduced by the electrons flowing from the anode. However, because the cathode is not immersed in a catholyte solution, various chemical species (e.g., Na⁺ and other ions diffusing across the cation exchange membrane) may rapidly build up on the surface of the electrode over time, thereby fouling and/or reducing the performance of the cathode. Moreover, it may be necessary to provide protons to the surface of the cathode in order to facilitate the reduction of oxygen to water.

In order to remove salts and other byproducts from the surface of an air cathode, and to provide protons for the redox reactions occurring at the cathode, a cathode rinsing assembly 24 may be provided for rinsing the cathode with a catholyte. Rinsing the cathode with catholyte also may reduce internal resistance (which may be important for high electricity production in bioelectrochemical systems includeing MDCs). In some embodiments, the catholyte may be effluent from the anode chamber. This effluent may have a low pH due to the production of protons at the anode, and thus may provide protons to the cathode while still effecting rinsing of salt species from the surface of the electrode. In some embodiments, the catholyte may be an aqueous acidic solution that will provide protons to the electrode while rinsing the surface of the cathode. For example, the catholyte may be a buffered acidic solution that may resist changes in pH resulting from consumption of protons. Alternatively, if a buffered catholyte solution is impractical due to the expense of such solutions (particularly in large scale MDCs), acidified water may be used as a catholyte (e.g., water acidified with a strong acid, such as sulfuric or hydrochloric acid).

Rinsing the cathode with an acidic catholyte, as opposed to immersing the cathode in a catholyte solution, provides a number of advantages. First, it provides a more environmentally friendly catholyte than conventional catholytes, which may include ferricyanide and other toxic chemicals. Second, it eliminates the need for a cathode chamber. Third, it reduces or eliminates the need for aeration by improving oxygen diffusion to the cathode. Fourth, rinsing the cathode with acidified water is substantially less expensive than rinsing with other conventional catholytes, including buffered aqueous solutions. Finally, it facilitates upscaled MDC processes, as described in more detail below.

An exemplary cathode rinsing assembly 24 may include at least one sprayer 38, a collector 40, and/or a recirculation assembly 42. The sprayer may be adapted to spray catholyte onto the cathode. For example, as shown in FIG. 1, the sprayer may be positioned to spray catholyte onto the top of the cathode from where the catholyte 39 drains down the side of the cathode, thereby rinsing the cathode. Alternatively or additionally, sprayers may be positioned to spray catholyte onto various portions of the cathode to ensure even rinsing of the cathode with catholyte. The collector may collect the catholyte after it has drained off the surface of the cathode. For example, the collector may be a tray, pan, reservoir, drain, etc. positioned beneath the cathode for receiving catholyte after it has drained from the cathode's surface. The collector may drain the used catholyte away from the system, and/or may direct the catholyte to the recirculation assembly for reuse. The recirculation assembly may include one or more conduits 44, one or more pumps 46 and/or a control assembly 48 that collectively function to recirculate the catholyte from the collector back to the sprayer, control the pH and salt concentration of the catholyte, and/or selectively provide new catholyte to the sprayer. Specifically, pumps may pump catholyte collected with the collector through a conduit to the sprayer and/or may pump fresh catholyte from a fresh catholyte reservoir (not shown) to the sprayer. It should be appreciated that recirculating catholyte will cause the catholyte pH to decrease, and the salt concentration to increase over time. As such, the catholyte may periodically need to be changed in order to ensure proper performance of the MDC. As such, the control assembly may include a pH meter, conductivity meter or any other type of sensor for directly or indirectly measuring the pH and/or salt concentration of the catholyte over time. In the event the pH or salt concentrations of the catholyte get too high, the control assembly may be configured to adjust or otherwise control the pH and/or salt concentration of the catholyte. For example, the control assembly may cause the recirculation system to selectively discharge some or all of the catholyte and/or provide fresh catholyte to the recirculation system in order to bring the pH and/or salt concentrations to acceptable or optimal levels. Alternatively or additionally, the controller may cause the addition of acids (e.g., sulfuric or hydrochloric acids, buffers, and the like) to the catholyte in order to selectively adjust its pH.

The MDCs disclosed herein may be coupled to a power source or load 28. As discussed in more detail in the Examples below, the rate that MDCs desalinate saline solutions may be controlled by adjusting the potentials and current, such as by adjusting the resistance or applying power. Operating an MDC at a maximum power point provides maximum energy production, which may be stored in an energy storage device, or used for downstream processes, such as downstream desalination processes like reverse osmosis and electrolysis. In contrast, operation at maximum current provides maximum desalination by the MDC, but little power is produced. A control system further may be provided that selectively adjusts the amount of current and power produced by an MDC. Moreover, the MDCs disclosed herein may be coupled to an energy storage device to optimize operation at maximum power or current.

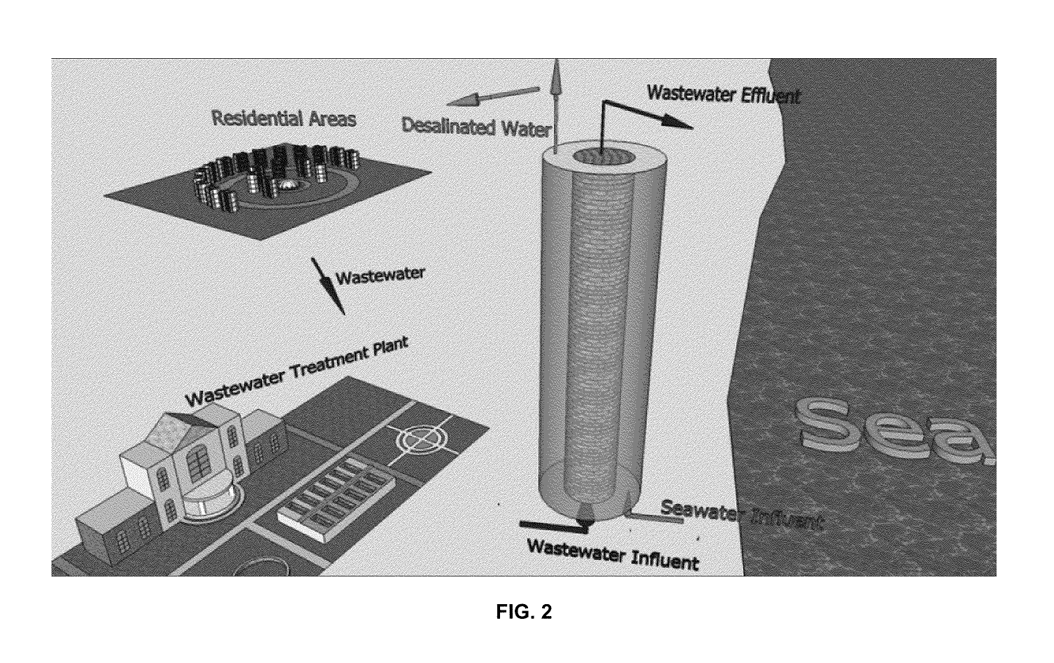

The desalination system and processes generally described above may be useful for providing freshwater to a community while simultaneously treating wastewater from the community. As shown in FIG. 2, wastewater produced by a community may pass through a wastewater treatment plant. Untreated or partially treated wastewater may be diverted to an MDC for further treatment in the anode chamber, thereby producing treated wastewater effluent as well as power and/or current. Power produced by the MDC may be used to power downstream water desalination processes, or other processes entirely. Current drives the desalination of water delivered to the salt solution chamber, whereupon the water is desalinated by the MDC. Desalinated water then may be diverted back into a community.

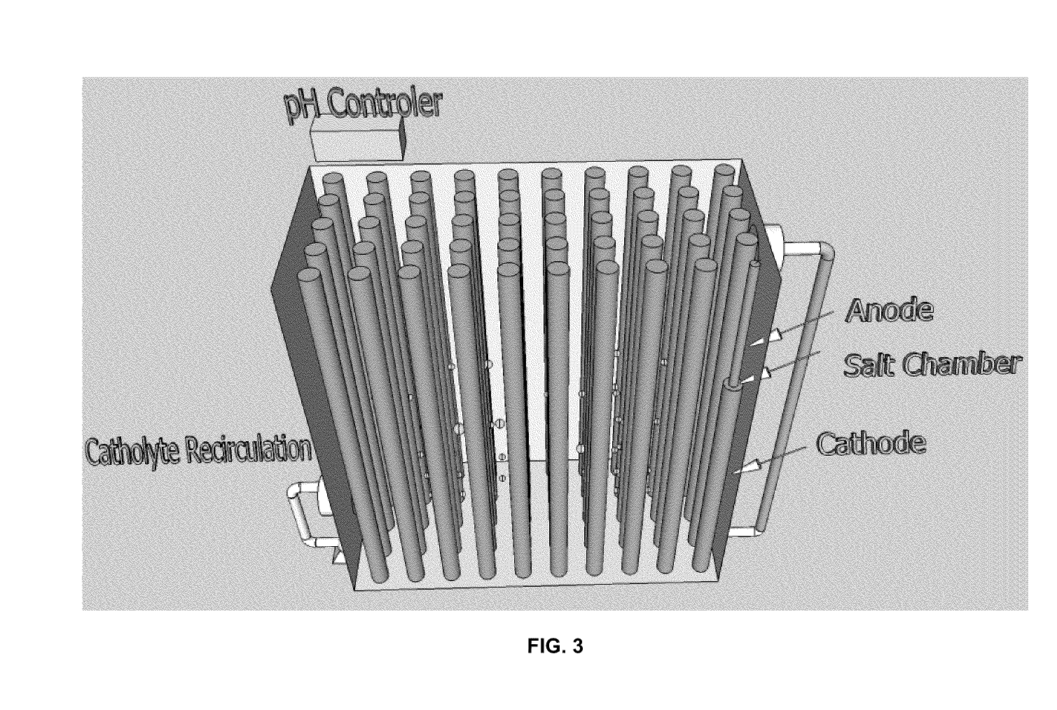

In some embodiments, a plurality of MDCs may be used in a microbial desalination system. FIG. 3 shows an exemplary microbial desalination system including a plurality of MDCs. In this embodiment, the system includes an exterior wall that defines the outer wall of a cathode chamber within which the MDCs are positioned. This embodiment includes a single cathode chamber for all of the MDCs. While the cathode chamber is shown as being foiled with liquid catholyte, it should be appreciated that other systems may fill the chamber with gases. In yet other embodiments, the microbial desalination system may not include an exterior wall or a cathode chamber at all, but instead may utilize one or more cathode rising assemblies, as discussed above.

Electrodes

Electrodes included in an MDC are electrically conductive. Exemplary conductive electrode materials include, but are not limited to, carbon paper, carbon cloth, carbon felt, carbon wool, carbon foam, carbon mesh, activated carbon, graphite, porous graphite, graphite powder, graphite granules, graphite fiber, a conductive polymer, a conductive metal, and combinations of any of these. A more electrically conductive material, such as a metal mesh or screen may be pressed against these materials or incorporated into their structure, in order to increase overall electrical conductivity of the electrode.

An anode and/or cathode may have any of various shapes and dimensions and may be positioned in various ways in relation to each other. For example, electrodes may be tubular, or cylindrical, where wastewater flows through tubes that are surrounded by saline solution to be desalinated (or vice versa). Electrodes may be placed in a co-cylindrical arrangement, or they can be wound as flat sheets into a spiral membrane device. Electrodes also may be square, rectangular, or any other suitable shape. The size of the electrodes may be selected based on particular applications. For example, the size of the anode relative to the cathode may be selected based on cost considerations, and considerations relating to performance. Moreover, where large volumes of substrates are to be treated in an MDC, electrodes having larger surface areas or multiple electrodes may be used.

Typically, an MDC's anode provides a surface for transfer of electrons produced when microbes oxidize a substrate. As discussed below, anodophilic bacteria may be used that attach to and grow on the surface of the electrode, in which case the anode may be made of a material compatible with bacterial growth and maintenance. MDC anodes may be formed of granules, mesh or fibers of a conductive anode material, (e.g., such as graphite, carbon, metal, etc.) that provides a large surface area for contact with bacteria. In preferred embodiments, the anode may be a brush anode, such as a carbon brush anode.

An MDC cathode either may be an air electrode (i.e., having at least one surface exposed to air or gasses) or may be configured to be immersed in liquid. Preferably, the cathode is an air electrode. A cathode preferably includes an electron conductive material. Materials that may be used for the cathode include, but are not limited to, carbon paper, carbon cloth, carbon felt, carbon wool, carbon foam, graphite, porous graphite, graphite powder, activated carbon, a conductive polymer, a conductive metal, and any combinations of these. In some embodiments, the cathode may comprise a catalyst, such as by mixing a catalyst with a polymer and a conductive material such that a membrane includes a conductive catalyst material integral with the membrane. For example, a catalyst may be mixed with a graphite or carbon coating material, and the mixture may be applied to a surface of a cation exchange material. Suitable catalysts may include, but are not limited to, metals (e.g., platinum, nickel, copper, tin, iron, palladium, cobalt, tungsten, alloys of such metals, etc.) as well as CoTMPP, carbon nanotubes and/or activated carbon, among others.

One or more additional coatings may be placed on one or more electrode surfaces. Such additional coatings may be added to act as diffusion layers, for example. A cathode protective layer, for instance, may be added to prevent contact of bacteria or other materials with the cathode surface while allowing oxygen diffusion to the catalyst and conductive matrix.

Ion Exchange Materials

A cation exchange material is permeable to one or more selected cations. Cation exchange material is disposed between the cathode and the saline solution chamber thereby forming a cation selective barrier there between. In some embodiments, the cation exchange material may be a cation exchange membrane. Cation exchange materials may include, but are not limited to, ion-functionalized polymers exemplified by perfluorinated sulfonic acid polymers such as tetrafluoroethylene and perfluorovinylether sulfonic acid copolymers, and derivatives thereof; sulfonate-functionalized poly(phenylsulfone); and sulfonic acid functionalized divinylbenzene cross-linked poly(styrene), among others. Specific examples include NAFION, such as NAFION 117, and derivatives produced by E.I. DuPont de Nemours & Co., Wilmington, Del., and CMI-7000 cation exchange membranes from Membrane International Inc., NJ, USA, among others. Also suitable are other varieties of sulfonated copolymers, such as sulfonated poly(sulfone)s, sulfoanted poly(phenylene)s, and sulfonated poly(imides)s, and variations thereof.

An anion exchange material is permeable to one or more selected anions. Anion exchange materials are disposed between the anode chamber and the saline solution chamber thereby forming an anion selective barrier there between. In some embodiments, the anode exchange material may be an anion exchange membrane. Anion exchange materials may include, but are not limited to, quaternary ammonium-functionalized poly(phenylsulfone); and quaternary ammonium-functionalized divinylbenzene cross-linked poly(styrene). Specific examples include, but are not limited to, AMI ion exchange membranes (e.g., AMI-7001) made by Membranes International, Inc. New Jersey, USA, AHA and A201 made by Tokuyama Corporation, JAPAN, and FAA made by Fumatech, GERMANY, among others.

Microbes

Microbes that may be used with the MDCs of this disclosure may include, but are not limited to, anodophilic bacteria, and exoelectrogens, among others. Anodophilic bacteria refer to bacteria that transfer electrons to an electrode, either directly or by endogenously produced mediators. In general, anodophilic bacteria are obligate or facultative anaerobes. Examples of bacteria that may be used with the MDCs disclosed herein include, but are not limited to bacteria selected from the families Aeromonadaceae, Alteromonadaceae, Clostridiaceae, Comamonadaceae, Desulfuromonaceae, Enterobacteriaceae, Geobacteraceae, Pasturellaceae, and Pseudomonadaceae. These and other examples of bacteria suitable for use in the MDCs disclosed herein are described in Bond, D. R., et al., Science 295, 483-485, 2002; Bond, D. R. et al., Appl. Environ. Microbiol. 69, 1548-1555, 2003; Rabaey, K., et al., Biotechnol, Lett. 25, 1531-1535, 2003; U.S. Pat. No. 5,976,719; Kim, H. J., et al., Enzyme Microbiol. Tech. 30, 145-152, 2002; Park, H. S., et al., Anaerobe 7, 297-306, 2001; Chauduri, S. K., et al., Nat. Biotechnol., 21:1229-1232, 2003; Park, D. H. et al., Appl. Microbiol. Biotechnol., 59:58-61, 2002; Kim, N. et al., Biotechnol. Bioeng., 70:109-114, 2000; Park, D. H. et al., Appl. Environ. Microbiol., 66, 1292-1297, 2000; Pham, C. A. et al., Enzyme Microb. Technol., 30: 145-152, 2003; and Logan, B. E., et al., Trends Microbiol., 14 (12):512-518.

Anodophilic bacteria preferably are in contact with an anode for direct transfer of electrons to the anode. However, in the case of bacteria which transfer electrons through a mediator, the bacteria may be present elsewhere in the anode chamber and still function to produce electrons transferred to the anode.

Anodophilic bacteria may be provided as a purified culture, enriched in anodophilic bacteria, or enriched in a specified species of bacteria, if desired. A mixed population of bacteria also may be provided, including anodophilic anaerobes and other bacteria. Finally, bacteria may be obtained from a wastewater treatment plant. Regardless of the source, the bacteria may be used to inoculate the anode.

Substrates

Substrates that may be used with MDCs of this disclosure include substrates that are oxidizable by bacteria or biodegradable to produce a material oxidizable by bacteria. Bacteria can oxidize certain inorganic as well as organic materials. Inorganic materials oxidizable by bacteria are well-known in the art and illustratively include hydrogen sulfide. A biodegradable substrate is an organic material biodegradable to produce an organic substrate oxidizable by bacteria. Any of various types of biodegradable organic matter may be used as “fuel” for bacteria in an MDC, including carbohydrates, amino acids, fats, lipids and proteins, as well as animal, human, municipal, agricultural and industrial wastewaters. Naturally occurring and/or synthetic polymers illustratively including carbohydrates such as chitin and cellulose, and biodegradable plastics such as biodegradable aliphatic polyesters, biodegradable aliphatic-aromatic polyesters, biodegradable polyurethanes and biodegradable polyvinyl alcohols. Specific examples of biodegradable plastics include polyhydroxyalkanoates, polyhydroxybutyrate, polyhydroxyhexanoate, polyhydroxyvalerate, polyglycolic acid, polylactic acid, polycaprolactone, polybutylene succinate, polybutylene succinate adipate, polyethylene succinate, aliphatic-aromatic copolyesters, polyethylene terephthalate, polybutylene adipate/terephthalate and polymethylene adipate/terephthalate.

Organic substrates oxidizable by bacteria are known in the art. Illustrative examples of an organic substrate oxidizable by bacteria include, but are not limited to, monosaccharides, disaccharides, amino acids, straight chain or branched C1-C7 compounds including, but not limited to, alcohols and volatile fatty acids. In addition, organic substrates oxidizable by bacteria include aromatic compounds such as toluene, phenol, cresol, benzoic acid, benzyl alcohol and benzaldehyde. Further organic substrates oxidizable by bacteria are described in Lovely, D. R. et al., Applied and Environmental Microbiology 56:1858-1864, 1990. In addition, a substrate may be provided in a form which is oxidizable by bacteria or biodegradable to produce an organic substrate oxidizable by bacteria. Specific examples of organic substrates oxidizable by bacteria include glycerol, glucose, sodium acetate, butyrate, ethanol, cysteine and combinations of any of these or other oxidizable organic substances. Substrates also may include municipal and industrial wastewater, organic wastes and some inorganic compounds, including, but not limited to ammonium and sulfides.

Reaction Conditions within the Anode Chamber

An aqueous medium in an anode chamber of the MDCs disclosed herein may be formulated to be non-toxic to bacteria in contact with the aqueous medium. Further, the medium or solvent may be adjusted to a be compatible with bacterial metabolism, for instance, by adjusting its pH to be in the range between about pH 3-9, preferably about 5-8.5, inclusive, by adding a buffer to the medium or solvent if necessary, and/or by adjusting the osmolarity of the medium or solvent by dilution or addition of a osmotically active substance. Ionic strength may be adjusted by dilution or addition of a salt for instance. Further, nutrients, cofactors, vitamins and/or other such additives may be included to maintain a healthy bacterial population, if desired. Reaction temperatures may be in the range of about 10-40° C. for non-thermophilic bacteria, although MDCs may be used at any temperature in the range of 0 to 100° C., inclusive by including suitable bacteria for growing at selected temperatures. However, maintaining a reaction temperature above ambient temperature may require energy input, and as such, it may be preferred to maintain the reactor temperature at about 15-25° C., without input of energy.

In operation, reaction conditions, such as pH, temperature, osmolarity, and ionic strength of the medium in the anode compartment, may be variable, or may change over time.

Embodiments of inventive compositions and methods are illustrated in the following examples. These examples are provided for illustrative purposes and are not considered limitations on the scope of inventive compositions and methods.

### EXAMPLES

### Example 1

### MDC Setup

Two cylindrical MDCs were provided having the general construction shown in FIG. 1. Each MDC 10 included an anode 12, an anode chamber 14, an anion exchange material 16, a cathode 18, a cation exchange material 20 and a saline solution chamber 22. For each of the MDCs, the anion exchange material (AMI-7001, Membrane International Inc., Glen Rock, N.J., USA) had a tubular or cylindrical shape that defined the cylindrical anode chamber and the inner wall of the saline solution chamber. Each cation exchange material (CMI-7000, Membrane International Inc.) surrounded the anion exchange material and had a tubular or cylindrical shape that defined the outer wall of the saline solution chamber. The membrane tubes were sealed using epoxy. The anode chamber included an inlet 30 at the bottom of the anode chamber and an outlet 32 at the top of the anode chamber. Similarly, the saline solution chamber included an inlet 34 at the bottom of the saline solution chamber and an outlet 36 at the top of the saline solution chamber.

For the first MDC, the anion exchange material 16 had a diameter of about 6.15 cm and a length of about 40 cm, and defined an anode chamber 14 having a liquid volume of about 500 mL. This anode chamber was filled with graphite granules (Carbon Activated Corp., Compton, Calif., USA) as the anode 12, and contained two graphite rods inserted into the graphite granules as current collectors. The cation exchange material 20 had a diameter of about 7.00 cm and a length of about 40 cm and, together with the anion exchange material, defined a saline solution chamber 22 having a liquid volume of about 350 mL. The cathode 18 was formed by applying a catalyst mixture (Pt/C power with water) to the outer surface of the cation exchange material (Pt loading rate of about 0.2 mg Pt/cm²) and then covering the catalyst with two layers of carbon cloth (Zoltek Companies, Inc., St. Louis, Mo., USA). The cathode was directly exposed to air. A Pt wire was used to connect the cathode and anode to an external circuit having a resistance of about 1Ω.

For the second MDC (a liter scale MDC), the anion exchange material 16 had a diameter of about 6.00 cm and a length of about 70 cm, and defined an anode chamber 14 having a liquid volume of about 1.9 L. Carbon brushes (Gordon Brush Mfg. Co., Inc., Commerce, Calif.) were used as the anode 12 instead graphite granules. The cation exchange material 20 had a diameter of 7.00 cm and a length of 70 cm and, together with the anion exchange material, defined a saline solution chamber 22 having a liquid volume of about 0.85 L. The cathode 18 was formed by applying a catalyst mixture (Pt/C power with Nafion solution) to the outer surface of the cation exchange material (Pt loading rate of about 0.4 mg Pt/cm²) and then covering the catalyst with two layers of carbon cloth (Zoltek Companies, Inc., St. Louis, Mo., USA). The cathode was directly exposed to air. A Pt wire was used to connect the cathode and anode to an external circuit having a resistance of about 1Ω, which was controlled by a high-accuracy decade box (HARS-X-3-0.001, IET Labs, Inc., Westbury, N.Y.).

### Example 2

### Operating Conditions for the First MDC

The first MDC was operated for more than four months, and it consistently removed salts while generating electricity.

Synthetic wastewater was prepared by dissolving sodium acetate (4 g/L), NH₄Cl (0.15 g/L), NaCl (0.5 g/L), MgSO₄ (0.015 g/L), CaCl₂ (0.02 g/L), KH₂PO₄ (0.53 g/L), K₂HPO₄ (1.07 g/L), yeast extract (0.1 g/L), and trace element (1 mL/L) into tap water. The synthetic wastewater was fed as influent 31 though the anode chamber inlet 30 and into the bottom of anode chamber 14 at a flow rate of about 0.7 mL/min. Effluent 33 was discharged from the top of the anode chamber through the anode chamber outlet 32. The effluent from the anode chamber was recirculated at about 120 mL/min and its HRT was about 12 h. The anode 12 was inoculated with a mixture of aerobic and anaerobic sludge from local wastewater treatment plants (Jones Island Wastewater Treatment Plant and South Shore Wastewater Treatment Plant, Milwaukee, Wis., USA). The sodium acetate in the wastewater provides an oxidizable carbon source that is oxidized during bacterial metabolism, thereby generating electrons and protons. The electrons were transferred through the anode to the cathode, where they reduced oxygen. Fluids traveling upwardly through the anode chamber were turbulently mixed, in part, due to the upflow design of the system, thus enhancing mass transport within the anode chamber.

Saline solution was prepared by dissolving NaCl in tap water (final concentration of about 30 g/L). The saline solution was fed as influent 35 into the bottom of the saline solution chamber 22 through the inlet 34 at a flowrate of about 0.06 mL/min (HRT of about 4 d) by a syringe pump (KD Scientific Inc., Holliston, Mass., USA) or about 0.25 mL/min (HRT 1 d) by a peristaltic pump (Cole-Parmer, Vernon Hills, Ill., USA). During desalination, the chloride ions moved into the anode chamber via the anion exchange membrane and sodium ions migrated to the cathode through the cation exchange membrane. The upflow design of the system enhanced mixing within the saline solution chamber, which may inhibit stratification of salts (use of flow obstacles, such as nets, spiral channels, spacers, springs, and the like also may enhance mixing and inhibit stratification). Saline solution effluent 37 (i.e., at least partially desalinated water) was discharged through the outlet 36 at the top of the saline solution chamber.

Acidified water having a pH of about 2 (adjusted with sulfuric acid) was prepared for use as a catholyte 39 to provide protons to, and rinse sodium ions from the surface of the cathode 18. Specifically, the cathode was rinsed with the catholyte by administering the catholyte to the top of the cathode at a flow rate of about 3 mL/min using porous piping (although a spray head also may be used). Catholyte was collected from the bottom of the cathode and recirculated using a pump and would be replaced at pH>10.

The MDC voltage was recorded every 3 minutes by a digital multimeter (2700, Keithley Instruments, Inc., Cleveland, Ohio, USA). The pH of the various solutions was measured using a Benchtop pH meter (Oakton Instruments, Vernon Hills, Ill., USA). The concentration of total dissolved solids (TDS) of the saline solution was measured using a benchtop conductivity meter (Mettler-Toledo, Columbus, Ohio, USA). Coulombic efficiency was calculated by dividing coulomb output (integrating current over time) by total coulomb input (based on total sodium acetate) according to previously known methods. Polarization curves were obtained using a potentiostat (Reference 600, Gamry Instruments, Warminster, Pa., USA) at a scan rate of 0.1 mV/s.

The maximum power density was calculated based on the anode liquid volume. The theoretic NaCl removal as a result of current generation was estimated based on that one mole of NaCl removal would require one mole of electrons. Charge transfer efficiency was estimated as the ratio between moles of the removed NaCl and moles of the produced electrons. The TDS removal rate (g TDS L⁻¹ d⁻¹) was calculated by the TDS removal per day (g d⁻¹) based on the reactor volume (L) of either salt solution (saline solution chamber) or wastewater (anode chamber).

### Example 3

### Operating Conditions for the Second MDC

The second MDC was operated for periods of more than eight months, and it consistently removed salts while generating electricity.

Synthetic wastewater was prepared by dissolving sodium acetate (3 g/L), NH₄Cl (0.15 g/L), NaCl (0.5 g/L), MgSO₄ (0.015 g/L), CaCl₂ (0.02 g/L), KH₂PO₄ (0.53 g/L), K₂HPO₄ (1.07 g/L), yeast extract (0.1 g/L), and trace element (1 mL/L) into tap water. The synthetic wastewater was fed as influent 31 though the anode chamber inlet 30 and into the bottom of the anode chamber 14 at a flow rate of about 4.0 mL/min. Effluent 33 was discharged from the top of the anode chamber through the anode chamber outlet 32. Effluent from the anode chamber was recirculated at about 200 mL/min and its HRT was about 8 h. The anode 12 was inoculated with a mixture of aerobic and anaerobic sludge from local wastewater treatment plants (Jones Island Wastewater Treatment Plant and South Shore Wastewater Treatment Plant, Milwaukee, Wis., USA). The sodium acetate in the wastewater provides an oxidizable carbon source that is oxidized during bacterial metabolism, thereby generating electrons and protons. The electrons were transferred through the anode to the cathode, where they reduced oxygen. Fluids traveling upwardly through the anode chamber were turbulently mixed, in part, due to the upflow design of the system, thus enhancing mass transport within the anode chamber.

Saline solution was prepared by dissolving NaCl in tap water (final concentration of about 35 g/L). Artificial seawater also was prepared by dissolving aquarium sea salts (Instant Ocean, Aquarium Systems, Inc., Mentor, Ohio) in tap water (final concentration of about 35 g/L). Either the saline solution or the artificial seawater solution was fed as influent 35 into the bottom of the saline solution chamber 22 through the inlet 34 at a flowrate adjusted to obtain the desired HRTs. During desalination, the chloride ions moved into the anode chamber via the anion exchange membrane and sodium ions migrated to the cathode through the cation exchange membrane. The upflow design of the system enhanced mixing within the saline solution chamber, which may inhibit stratification of salts (use of flow obstacles, such as nets, spiral channels, spacers, springs, and the like also may enhance mixing and inhibit stratification). Saline solution effluent 37 (i.e., at least partially desalinated water) was discharged through the outlet 36 at the top of the saline solution chamber.

Acidified water having a pH of about 2.5 (adjusted with sulfuric acid) was prepared for use as a catholyte 39 to provide protons to, and rinse sodium ions from the surface of the cathode 18. Specifically, the cathode was rinsed with the catholyte by administering the catholyte to the top of the cathode at a flow rate of about 4 mL/min using porous piping (although a spray head also may be used). Catholyte was collected from the bottom of the cathode and recirculated using a pump and would be replaced at pH>10.

The MDC voltage was recorded every 3 minutes by a digital multimeter (2700, Keithley Instruments, Inc., Cleveland, Ohio, USA). The pH of the various solutions was measured using a Benchtop pH meter (Oakton Instruments, Vernon Hills, Ill., USA). The conductivity of the various solutions was measured using a Benchtop conductivity meter (Mettler-Toledo, Columbus, Ohio). The concentration of chemical oxygen demand (COD) was measured using a colorimeter according to the manufacturer's procedure (Hach DR/890, Hach Company, Loveland, Colo.). The polarization curve was obtained using a potentiostat (Reference 600, Gamry Instruments, Warminster, Pa., USA) at a scan rate of 0.1 mV/s.

The maximum power density was calculated based on the anode liquid volume. The theoretic NaCl removal as a result of current generation was estimated based on that one mole of NaCl removal would require one mole of electrons. The TDS removal rate (g TDS L⁻¹ d⁻¹) was calculated by the TDS removal per day (g d⁻¹) based on the reactor volume (L) of either salt solution (saline solution chamber) or wastewater (anode chamber). The additional water flux in the saline solution compartment was determined by measuring the difference of the volume between the influent to and effluent from the saline solution chamber over time.

The estimated energy requirement by reverse osmosis (RO) is based on a constant driving force and recovery rate of 50%. The energy to transport seawater from the sea to the pretreatment is assumed as 1.5 kWh/m³. The energy requirement was calculated according to the following equations:

$$\begin{matrix}E = 1.5 + \frac{( PI / R + 20 ) x}{70} & ( 1 ) \\ PI = \frac{25 x}{3.5} & ( 2 )\end{matrix}$$

where E is the energy requirement (kWh/m³), PI is osmotic pressure (bar), R is the recovery rate (50%) and x is salinity (e.g., 3.5 for 35 g/L).

### Example 4

### Startup and Operation of MDCs

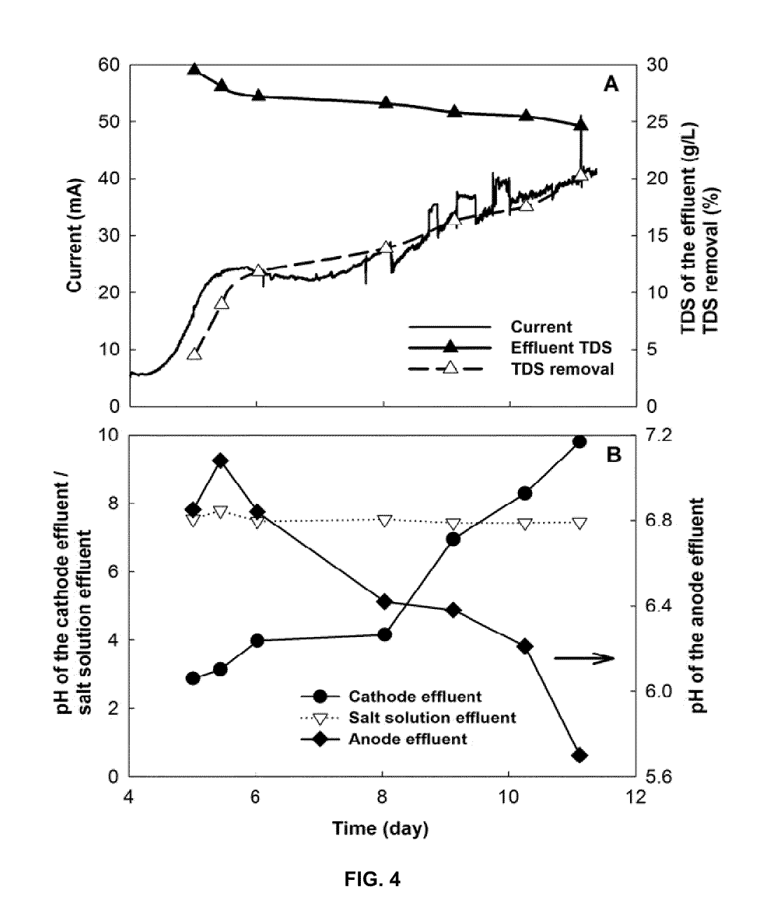

FIG. 4 is a pair of graphs showing the performance of the first MDC during a startup period, where the top graph (A) shows current generation, total dissolved solids (TDS), and % TDS removal, and the bottom graph (B) shows the variation of pH in the effluents from the cathode and the salt solution and anode chambers. At a salt solution HRT of 1 d, the electric current increased from 5 to 40 mA over the course of about 10 days, while the TDS concentration in the effluent of salt solution decreased from 30.8 to 24.6 g/L and the % TDS removal increased to 20.2%. This demonstrates a relatively quick startup of the reactor in just a few days time. The coulombic efficiency at 40 mA output was about 11%.

The change in pH of the effluents from the anode chamber (i.e., the anode effluent) and the salt solution chamber (i.e., the salt solution effluent), and of the catholyte (i.e., the cathode effluent) were in accordance with those of other microbial fuel cells (MFCs). The pH of the anode effluent decreased from 6.85 to 5.70, indicating anaerobic microbial activity, and accumulation of protons within the anode chamber. The pH of the salt solution effluent was relatively constant at 7.52±0.12, though lower than its influent pH of 8.14±0.06. The pH of the cathode effluent increased from 2.87 to 9.80, resulting from cathode oxygen reduction. The dramatic change of the pH of the catholyte suggested that protons were rapidly consumed by the reactions at the cathode, and even the acidified catholyte might not be sufficient to sustain an effective cathode reaction with a high current generation. To address this, a buffered catholyte may be used, but for large scale processes, buffered catholyte may be prohibitively expensive. Alternatively, as discussed above, the pH of the catholyte may be monitored and controlled, such as by adding additional acid, or by periodically replacing the catholyte with new acidified water.

Based on the information of current generation, pH variation and % TDS removal, it was reasonable to conclude that an active bio-electricity generation led to salt removal in the salt solution. The measurement of TDS concentrations in the anode and cathode effluents demonstrated an increase in both streams (data not shown), indicating the “relocation” of salts from the salt solution into the anolyte and catholyte. The TDS removal rate at HRT 1 d was 6.20 g TDS L⁻¹ d⁻¹ (salt solution volume) or 4.34 g TDS L⁻¹ d⁻¹ (wastewater volume). In order to address the buildup up salts in the catholyte, the catholyte may need to be periodically replaced with new acidified water.

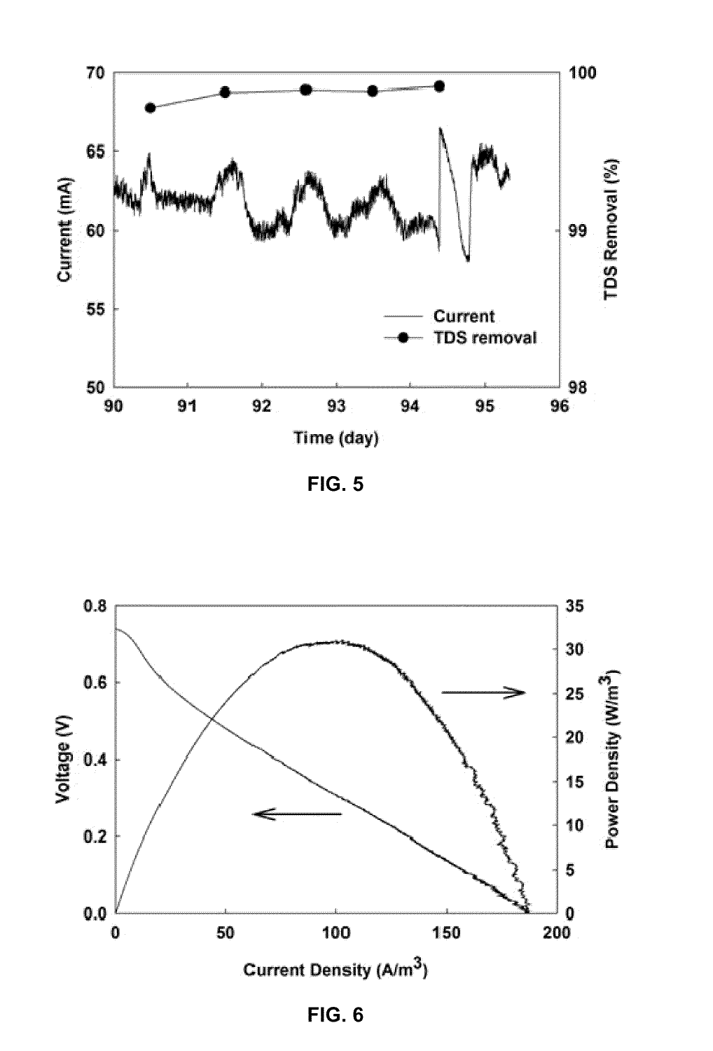

The HRT of the saline solution has an important influence on the relative amount of TDS removal, since a longer retention time will allow more salts to be involved in current generation and thus to be removed from the saline solution. FIG. 5 is a graph showing % TDS removal and current generation of the first MDC between days 90 and 96, with a hydraulic retention time (HRT) period of 4 days. As can be seen, extending the HRT of saline solution from 1 to 4 d improves the % TDS removal to 99.88±0.05% (i.e., nearly 100%). The desalinated water contained 39.9±16.2 mg TDS/L, which is substantially lower than the 500 mg/L maximum level of TDS mandated by the U.S. Environmental Protection Agency for drinking water. The TDS removal rate at HRT 4 d was 7.50 g TDS L⁻¹ d⁻¹ (salt solution volume) or 5.25 g TDS L⁻¹ d⁻¹ (wastewater volume). Compared with the results of the HRT 1 day, there was a 21% increase in TDS removal per day. This increase was likely due to the increased electric current generation from 42.4±1.3 mA (HRT 1 d) to 62.6±2.1 mA (HRT 4 d). With 62 mA output, the coulombic efficiency was about 17%. The increase in overall TDS removal (from 20% to more than 99%) was mainly a result of the extended retention time.

### Example 5

### Charge Transfer Efficiency and TDS Removal Rate

At the current production of 42 mA (HRT 1 d), the charge transfer efficiency (electrons harvested to NaCl removed) of the first MDC was 98.6% based on the assumption that removal of one mole of NaCl would require one mole of electrons. Therefore, 98.6% of the produced electrons were used for NaCl removal as opposed to driving other processes. The loss of electrons to other processes than NaCl removal will not affect current generation; however, it will reduce the efficiency of desalination, in terms of energy. That is, more organic oxidation will be required to supply electrons for desalination than what is actually needed.

The TDS removal rate is affected by many factors, such as salt solution volume, wastewater volume, HRTs of wastewater and salt solution, membrane surface area, microbial oxidation and oxygen reduction, and is thus difficult to be well defined. Here, the TDS removal rate based on the MDC's water volumes and time under a condition that electron supply (anode organics) was sufficient for NaCl removal. When the highest TDS removal was achieved, we supplied 4 L of wastewater to desalinate 350 mL of salt solution (11.4:1). The TDS removal rate at HRT 4 d was 7.50 g TDS L⁻¹ d⁻¹ (salt solution volume) or 5.25 g TDS L⁻¹ d⁻¹ (wastewater volume).

### Example 6

### Proton Transport and Bipolar Electrodialysis Effects

At HRT 4 d, the pH of the effluent from the saline solution chamber of the first MDC was 6.33±0.15, more than one unit lower than that at HRT 1 day. This slightly acidified process suggested accumulation of protons in the saline solution chamber. Proton movement from the catholyte rinse through the cation exchange material into the saline solution might play a role in pH drop because ion exchange membranes cannot stop protons passing through. A lower current generation could allow more proton transport through the ion exchange membrane because of less consumption of protons by the cathode reaction. The fact that pH drop at a higher current generation (HRT 4 d) was larger than that at a lower current (HRT 1 d) suggested that there were other processes that could cause a pH drop. Furthermore, at the current output of 62 mA, the charge transfer efficiency was 81%, lower than the charge transfer efficiency of 98.6% at HRT 1 d, suggesting the presence of other processes driven by electron transport. A potential candidate process could be water dissociation caused by bipolar electrodialysis. MDCs contain both cation and anion exchange membranes and thus a bipolar process is created.

A previous study also revealed the possibility of applying bipolar process to generate bio-electricity in microbial fuel cells. See Ter Heijne, A., Hamelers, H. V., De Wilde, V., Rozendal, R. A., Buisman, C. J., “A bipolar membrane combined with ferric iron reduction as an efficient cathode system in microbial fuel cells,” Environmental Science & Technology, 2006, 40(17), pp 5200-5. Bipolar membranes have been used for electrodialysis of salt solutions into acids and bases. They also can be used to directly acidify or basify streams without adding chemicals. Driven by an electric force (current or potential), bipolar membranes can separate ionic species in solution. Salt removal in MDCs is similar to an electrodialysis process, except that no external electric current/potential is applied. Instead, biological oxidation of organic compounds in the anode of a MDC produces electric current (with cathode reactions) and salt movement is a part of the electricity-generating process. That is, without salt dissociation and movement into different compartments, MDCs will not produce electric current.

A bipolar electrodialysis process has some potential effects that may be of concern to the future application of MDC technology. One effect will cause water loss. One of the major purposes of MDCs is to produce drinking water or pre-treated water for further purification. In the presence of large amount of salts at the early stage of desalination, current generation is associated with salt removal; however, at the later stage when salt is at a very low concentration, water dissociation may be involved in current production, like that in electrodialysis. See Tanaka, Y. “Water dissociation in ion-exchange membrane electrodialysis,” Journal of Membrane Science, 2002, 203(1-2), pp 227-244. The present data showed that current generation did not decrease when salt concentration dropped below 1% of its influent concentration. Assuming that current generation was only due to water dissociation, it would correspond to 1.1% of water loss. Our MDC has not been optimized to its maximum capacity of current generation. At a coulombic efficiency of 60-80% that is achievable in MFCs, current generation could lead to 4-5% of water loss. This water loss could potentially be significant for the drinking water supply, considering that additional water loss may occur in other steps of the treatment process. On the other hand, however, if we use MDCs as a sole desalination process to directly produce drinking water, this water loss may not be important because we eliminate the water loss by downstream purification processes. The other effect will result in a pH change. Our experiment showed a decreased pH of the desalinated water from 7.52 to 6.33 at higher TDS removal rate. A further decrease in pH will create a water quality that will not be appropriate as drinking water. The exact reason for the pH change is unclear at this moment and requires further investigation, but we think that it may be related to cathode reaction because a pH decrease suggests inefficient proton transport into the cathode compartment. A proper control of TDS removal may prevent pH decrease.

### Example 7

### Power Production

During the process of desalination, bio-electricity was constantly produced by the first MDC. The polarization curve at HRT 4 d showed an open-circuit potential of 0.74 V and the maximum power density of 30.8 W/m³ (FIG. 6). The short-circuit current was 93 mA (186 A/m³), 50% higher than the operating current of 62 mA (at 1Ω). This difference demonstrated the potential of further improvement of current generation, as well as desalination efficiency. Specifically, the TDS removal rate may be increased by 50% from 7.50 to 11.25 g TDS L⁻¹ d⁻¹ (salt solution volume) if the first MDC is operated at a higher current output (close to its highest output). As a result, more than 99% of TDS removal may be achieved within 2.6 days, which is much shorter than 4 days. This improvement may increase the production of desalinated water and generate significant economic benefits. In practice, operating the MDCs with the short-circuit current is possible.

MDCs have multiple functions with multiple products (electric energy and desalinated water). It will be desirable to emphasize one product, which will affect an MDCs' operation. For the purpose of electric energy production, MDCs can be operated at their maximum power output (but with a lower current generation and lower desalination efficiency); however, if desalination is the main goal, MDCs can be operated at the highest (possible) current that will result in a high desalination efficiency (but with a lower power output). Since the electric energy produced can be used by downstream desalination processes (e.g., RO process), there might be a counterbalance between a higher power output and a lower desalination efficiency when MDCs function as pre-desalination processes.

### Example 8

### Desalination of Salt Solution or Artificial Seawater

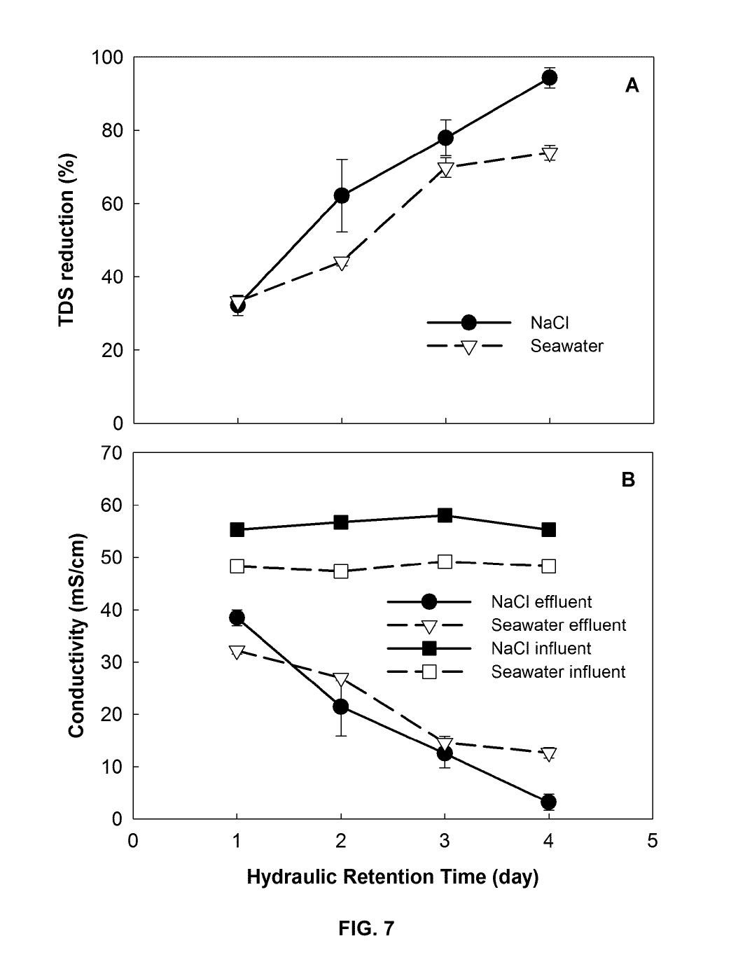

During the operating period, the second MDC was capable of desalinating both saline solution (containing NaCl) and artificial seawater (containing sea salts) with a notable difference in performance. FIG. 7 is a pair of graphs showing the desalination performance of the second MDC, where the top graph (A) shows the TDS reduction in salt solution and artificial seawater at different HRTs, and the bottom graph (B) shows the conductivity of the influents to the saline solution chamber and effluents from the saline solution chamber for both salt water and artificial seawater at different HRTs. As shown in FIG. 7A, the TDS reduction for both saline solution and artificial seawater increased with an increasing HRT for the fluid in the saline solution chamber. At a HRT of 4 d, the MDC removed 94.3±2.7% and 73.8±2.1% of the TDS contents in saline solution and artificial seawater, respectively. Accordingly, the conductivity of the effluents from the saline reached the lowest of 3.2±1.5 mS/cm and 12.6±1.0 mS/cm for the saline solution and the artificial seawater, respectively, as shown in FIG. 7B. It should be noted that the influents of the saline waters contained different conductivities: 56.7±1.4 mS/cm for saline solution and 48.3±0.9 mS/cm for the artificial seawater. The TDS removal rate for the saline solution was 11.61±1.69 g TDS L⁻¹ d⁻¹ (saline solution volume) or 5.20±0.75 g TDS L⁻¹ d⁻¹ (wastewater volume). The removal rate for artificial seawater was 9.99±2.61 g TDS L⁻¹ d⁻¹ (seawater volume) or 4.47±1.17 g TDS L⁻¹ d⁻¹ (wastewater volume). Meanwhile, the MDC removed 92.0±0.4% of COD in its anode at the loading rate of 6.78±0.36 g COD L⁻¹ d⁻¹, irrespective of salt solution or artificial seawater.

Compared with the performance of the first MDC, the second MDC maintained a similar TDS removal rate based on wastewater volume, or it improved the TDS removal based on salt solution volume, even though the volume of the reactor was about three times larger. This is a positive indication that performance may be maintained at a similar level while scaling up the volume of the MDC. The improved TDS removal rate based on the volume of saline solution was likely due to a larger ratio between the wastewater volume and salt solution volume (2.2:1) as compared to the 1.4:1 ratio used with the first MDC. A larger ratio between the two volumes will benefit salt removal; the detailed reasons remain unclear, but may be attributable to less salt accumulation in the anode due to a larger flux of the anolyte, a sufficient organic supply for providing electrons, and a larger membrane surface for facilitating ion exchange.

These results demonstrate that seawater can be desalinated as expected, but at a slightly lower efficiency than a NaCl solution. As shown in FIG. 7A, the highest TDS removal with artificial seawater was about 20% less than NaCl solution. The lower efficiency may be related to the complex composition of seawater. In addition to the predominant species such as Na⁺ and Cl⁻, seawater also contains Ca²⁺, Mg²⁺, SO₄²⁻, K⁺, and other various dissolved and suspended components. The lower conductivity of seawater compared with NaCl solution at the same concentration (35 g/L) resulted in a higher ohmic resistance of 6.69Ω compared with 5.94Ω with the NaCl solution. It also suggested the presence of non-conductive compounds in seawater (e.g., silica and clay in a very fine or colloidal form). Some of those compounds may form a precipitate on the surface of the ion exchange membranes, thereby causing membrane fouling. Long-term operation also may introduce microbial growth and biofouling, but is not expected to be as serious as that in conventional desalination systems (e.g., RO) because of the different mechanisms of ion movement (ion exchange in MDCs vs. filtration in RO).

### Example 9

### Contributions to TDS Reduction

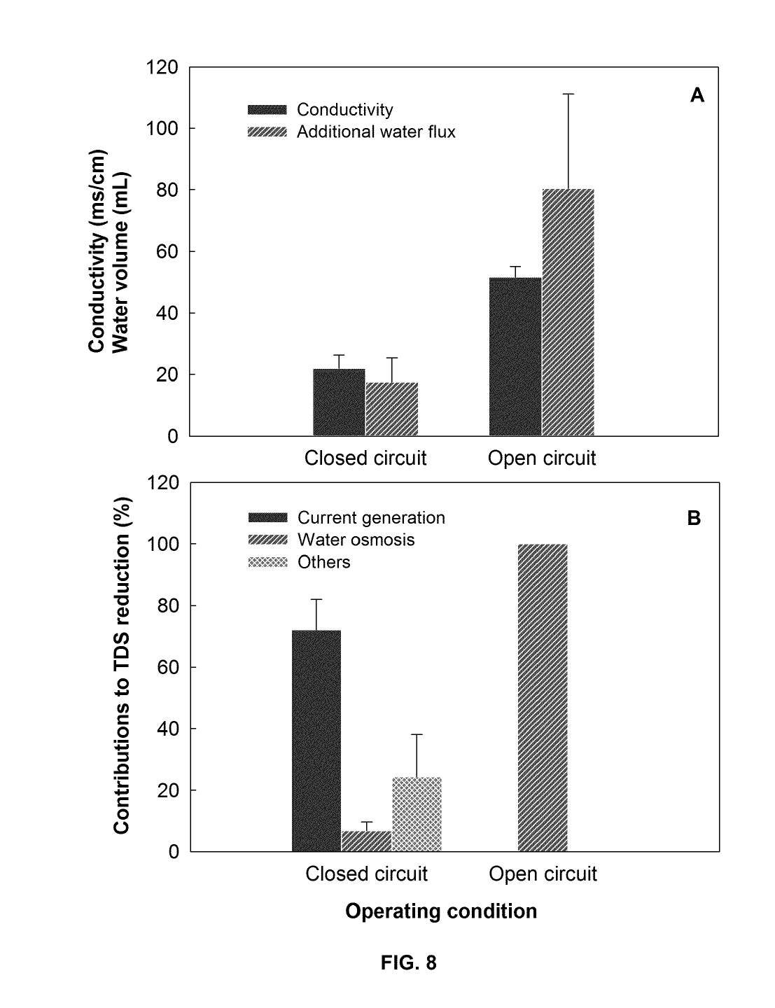

During the various experiments with the second MDC, it was observed that more water flowed out of the saline solution compartment s effluent than was fed in as influent. The measurements at a HRT 2 d with NaCl solution showed additional water flux of about 17.6±7.7 mL and 80.4±30.7 mL under the closed- and open-circuit conditions, respectively (FIG. 8A). The added water was likely the result of water osmosis from both the fluid in the anode chamber and possibly even from the catholyte rinse into the saline solution chamber due to the gradient of salt concentrations across the ion exchange membranes. The higher conductivity of 51.7±3.5 mS/cm under the open-circuit condition compared with 21.9±4.4 mS/cm under the closed-circuit condition supports that current generation stimulates TDS removal in the MDC. Consequently, the open-circuit condition had a higher gradient that tended to cause more water flux into the saline solution chamber thereby diluting the salt solution, which might be why conductivity was reduced about 6% in the absence of current generation. While osmosis would not remove TDS, it would lower the TDS concentration via dilution.

Factors included in the present analysis included electric current, water osmosis, and others such as dialysis and ion exchange. The results suggested that under the open-circuit condition, TDS reduction was primarily due to water osmosis. With the closed-circuit condition, electric current accounted for 72.2±9.9% of the reduction in TDS, water osmosis contributed 6.8±2.8% in reducing TDS concentration, and the rest (24.4±13.8%) was from others, as shown in FIG. 8B. The data demonstrated that desalination was not the sole result of current generation; however, more than enough current was produced for desalination, and salt reduction due to other factors was not observed.

Water osmosis in the MDC, although not significant under the closed-circuit condition, potentially could be beneficial because it can extract clean water, especially from the wastewater solution in the anode chamber, and can increase the water production of desalination. The existence of ion exchange membranes would preclude microorganisms and other contaminants from entering the saline solution chamber; therefore, the additional water would not affect the quality of the desalinated water. This is important to downstream the RO process, since biofouling has become a serious problem to RO systems.

### Example 10

### High Power vs. High Current

As discussed above, MDCs may be operated under high power output or high current generation. MDCs will remove less TDS at high power output (near maximum power output) than at high current generation (near short circuit current), but the former condition can produce more electric power that will benefit downstream desalination when MDCs act as pre-desalination processes. The energy production and desalination efficiency of the second MDC were compared under those two conditions.

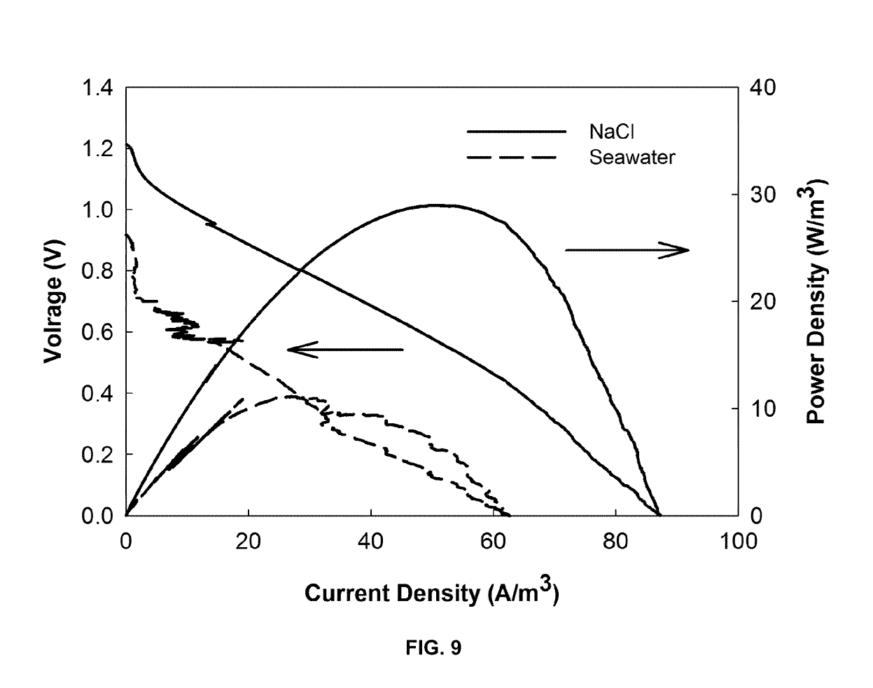

Polarization curves were used to determine the external resistance at which the maximum power output was achieved. As shown in FIG. 9, the second MDC produced a maximum power density of 28.9 and 11.1 W/m³ with salt solution and artificial seawater, respectively. The maximum power density with salt solution was close to that of our the smaller-scale first MDC (30.8 W/m³). According to the slope of the voltage drop, an internal resistance (ohmic resistance) of 6Ω was estimated; therefore, the MDC was operated at 6Ω to reach a stable performance to collect data.

A significant discrepancy in power production was observed between potentiostat-measured polarization curves and actual operation. At 6Ω, the second MDC produced a sustainable power that was 50-54% of the maximum power density obtained from the polarization curves (Table 1), although a slow scan rate of 0.1 mV/s was employed during the polarization test, which was expected to produce more accurate results. This difference required cautious reporting of the performance of bioelectrochemical systems using polarization curves to avoid false results (instant maximum power vs. sustainable maximum power). An interesting observation is that the open circuit potential (OCP) with salt solution reached 1.2V, the highest OCP ever reported in any microbial fuel cell-related study. Nevertheless, the sustainable data obtained from the operation at 6Ω was used to represent the condition of maximum power output, and the data obtained from the operation at 0.1Ω was used to represent high current generation. The main results are summarized in Table 1 for both salt solution and artificial seawater.

TABLE 1
Comparison of performance of MDC under regular operating condition (0.1 Ω) and high
power output (6 Ω) with either salt solution or artificial seawater (HRT of 2 days).

| | External resistance of 0.1 Ω | | | | External resistance of 6 Ω | | | |
|---|---|---|---|---|---|---|---|---|
| | k^{a} | TDS^{b} | I^{c} | P^{d} | k^{a} | TDS^{b} | I^{c} | P^{d} |
| | (mS/cm) | (%) | (mA) | (W/m³) | (mS/cm) | (%) | (mA) | (W/m³) |
| Salt | 21.9 ± 4.4 | 60.1 ± 6.5 | 143 | 1.1 | 31.7 ± 3.9 | 42.3 ± 7.0 | 70 | 15.6 |
| solution | | | | | | | | |
| Artificial | 27.2 ± 0.6 | 42.5 ± 1.4 | 86 | 0.4 | 33.5 ± 0.5 | 29.1 ± 1.0 | 42 | 5.6 |
| seawater | | | | | | | | |

^{a}Effluent conductivity.
^{b}TDS reduction.
^{c}Mean value of electric current.
^{d}Mean value of power density.

Several assumptions were made to facilitate this analysis. First, the MDC acts as a pre-desalination system and its effluent is further desalinated by an RO system. Second, the estimate is based on one day's operation and thus the water production of 425 mL (at saline water HRT of 2 d). Third, the specific energy of an RO system, when treating 3.5% saline water, is 3.7 kWh/m³. Last, to simplify the analysis, the difference between salt solution and artificial seawater was disregarded when estimating energy consumption by the RO system. In practice, energy consumption is affected by seawater quality.

The data indicated that, given high energy efficiency, it could be favorable if the MDC operates under the condition of high power output when treating salt solution while high current generation would be desired with seawater desalination. With salt solution, the MDC could bring the salinity down to about 22 mS/cm and about 32 mS/cm when operated at 0.1Ω and 6Ω, respectively (Table 1), resulting in an energy requirement of 9.8×10⁻⁴ kWh and 1.2×10⁻³ kWh by the downstream RO system for further desalination (Table 2); thus, 2.5×10⁻⁴ kWh is needed to reduce the gap of salinity between two operating conditions. Meanwhile, the second MDC produced 4.9×10⁻⁵ kWh and 7.1×10⁻⁴ kWh under two conditions. The difference of 6.6×10⁻⁴ kWh could be used to reduce the salinity gap and provide additional energy to the RO system. In terms of energy benefits, high power output was more favorable with salt solution. However, this analysis was based the assumption that 100% of the energy produced by MDC could be used by a downstream system. In reality, energy loss may occur during the transfer, storage, and use of energy. A similar analysis was applied to artificial seawater but the results suggested no significant difference. Considering the potential energy loss, high current generation is more advantageous for desalination. The total energy produced at the high-power condition, with 100% efficiency, could contribute 58.1% (salt solution) and 16.5% (artificial seawater) of the energy required by the downstream RO system, which is much higher than 5.0% and 1.4% when operated at the high-current condition. If the specific energy of the RO system can be further reduced, the high-power operation of the MDC will be more advantageous. The actual energy efficiency will greatly affect the results of the above analysis.

TABLE 2
Energy estimate based on one day's operation (HRT of 2 days), including energy production in
the MDC under two conditions and energy required by downstream RO system.

| | Water | E_{MDC-0.1 Ω}^{a} | E_{MDC-6 Ω}^{b} | ΔE^{c} | E_{RO-0.1 Ω}^{d} | E_{RO-6 Ω}^{e} | ΔE_{RO}^{f} |
|---|---|---|---|---|---|---|---|
| | production | (kWh) | (kWh) | (kWh) | (kWh) | (kWh) | (kWh) |
| Salt | 425 mL | 4.9 × 10⁻⁵ | 7.1 × 10⁻⁴ | 6.6 × 10⁻⁴ | 9.8 × 10⁻⁴ | 1.2 × 10⁻³ | 2.5 × 10⁻⁴ |
| solution | | | | | | | |
| Artificial | 425 mL | 1.8 × 10⁻⁵ | 2.5 × 10⁻⁴ | 2.4 × 10⁻⁴ | 1.2 × 10⁻³ | 1.5 × 10⁻³ | 2.6 × 10⁻⁴ |
| seawater | | | | | | | |

^{a}Energy production from the MDC when desalinating 425 mL of saline waters at 0.1 Ω.
^{b}Energy production from the MDC when desalinating 425 mL of saline waters at 6 Ω.
^{c}Difference in energy production between the MDC at 0.1 and 6 Ω.
^{d}Energy required by ROs to treat 425 mL of saline effluent from the MDC at 0.1 Ω.
^{e}Energy required by ROs to treat 425 mL of saline effluent from the MDC at 6 Ω.
^{f}Difference in energy requirement by ROs when treating 425 mL of saline effluents from the MDC between two conditions.

The systems, compositions and methods disclosed herein are not limited in their applications to the details described herein, and are capable of other embodiments and of being practiced or of being carried out in various ways. The phraseology and terminology used herein is for the purpose of description only, and should not be regarded as limiting. Ordinal indicators, such as first, second, and third, as used in the description and the claims to refer to various structures, are not meant to be construed to indicate any specific structures, or any particular order or configuration to such structures. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention.

Recitation of ranges of values herein are merely intended to serve as a shorthand method of referring individually to each separate value falling within the range, unless otherwise indicated herein, and each separate value is incorporated into the specification as if it were individually recited herein. For example, if a parameter is described as having a range from 1 to 50 units, it is intended that values such as 2 to 40 units, 10 to 30 units, 1 to 3 units, etc., are expressly enumerated in the specification. These are only examples of what is specifically intended, and all possible combinations of numerical values between and including the lowest value and the highest value enumerated are to be considered to be expressly stated in this application.

Any patents or publications mentioned in this specification are incorporated herein by reference to the same extent as if each individual publication is specifically and individually indicated to be incorporated by reference. Further, no admission is made that any reference, including any non-patent or patent document cited in this specification, constitutes prior art. Unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein.

### REFERENCES

The following references are herein incorporated by reference in their entireties for all purposes:
1. Aelterman, P., Rabaey, K., Pham, H. T., Boon, N. and Verstraete, W., “Continuous electricity generation at high voltages and currents using stacked microbial fuel cells,” Environmental Science and Technology, 2010, 40(10), pp 3388-3394.
2. Cao, X., Huang, X., Liang, P., Xiao, K., Zhou, Y., Zhang, X., Logan, B. E., “A new method for water desalination using microbial desalination cells,” Environmental Science & Technology, 2009, 43(18), pp 7148-52.
3. Chen, X.; Xia, X.; Liang, P.; Cao, X.; Sun, H.; Huang, X., “Stacked microbial desalination cells to enhance water desalination efficiency,” Environmental Science & Technology, 2011, 45, pp 2465-2470.
4. Clauwaert, P.; Aelterman, P.; Pham, T. H.; De Schamphelaire, L.; Carballa, M.; Rabaey, K.; Verstraete, W., “Minimizing losses in bio-electrochemical systems: the road to applications,” Applied Microbiology and Biotechnology, 2008, 79(6), pp 901-913.
5. He, Z., Minteer, S. D., Angenent, L. T., “Electricity generation from artificial wastewater using an upflow microbial fuel cell,” Environmental Science and Technology, 2005, 39(14), 5262-5267.
6. He, Z.; Wagner, N.; Minteer, S. D.; Angenent, L. T., “An upflow microbial fuel cell with an interior cathode: assessment of the internal resistance by impedance spectroscopy,” Environmental Science & Technology, 2006, 40(17), pp 5212-5217.
7. Huang, C. H., Xu, T. W., “Electrodialysis with bipolar membranes for sustainable development,” Environmental Science & Technology, 2006, 40(17), pp 5233-5243.
8. Huang, Y., He, Z. and Mansfeld, F., “Performance of microbial fuel cells with and without Nafion solution as cathode binding agent,” Bioelectrochemistry, 2010, 79, pp 261-264.
9. Jacobson, K., Drew, D. and He, Z., “Use of a Liter-Scale Microbial Desalination Cell As a Platform to Study Bioelectrochemical Desalination with Salt Solution or Artificial Seawater,” Environmental Science and Technology, 2011, 45(10), pp 4652-4657.
10. Jacobson, K., Drew, D. and He, Z., “Efficient salt removal in a continuously operated upflow microbial desalination cell with an air cathode,” Bioresource Technology, 2010, 102, pp 376-380.
11. Karagiannis, I. C., Soldatos, P. G., “Water desalination cost literature: review and assessment,” Desalination, 2008, 223(1-3), pp 448-456.
12. Khawaji, A. D., Kutubkhanah, I. K., Wie, J. M., “Advances in seawater desalination technologies,” Desalination, 2008, 221(1-3), pp 47-69.
13. Kumar, M.; Adham, S. S.; Pearce, W. R., “Investigation of seawater reverse osmosis fouling and its relationship to pretreatment type,” Environmental Science & Technology, 2006, 40(6), pp 2037-44.
14. Luo, H.; Jenkins, P. E.; Ren, Z., “Concurrent desalination and hydrogen generation using microbial electrolysis and desalination cells,” Environmental Science & Technology, 2011, 45(1), pp 340-344.
15. Liu, H.; Grot, S.; Logan, B. E., “Electrochemically assisted microbial production of hydrogen from acetate,” Environmental Science & Technology, 2005, 39(11), p 4317-4320.
16. Logan, B. E., “Scaling up microbial fuel cells and other bioelectrochemical systems,” Applied Microbiology and Biotechnology, 2010, 85(6), pp 1665-1671.
17. Logan, B. E., Hamelers, B., Rozendal, R. A., Schroder, U., Keller, J., Freguia, S., Aelterman, P., Verstraete, W., Rabaey, K. “Microbial fuel cells: methodology and technology,” Environmental Science and Technology, 2006, 40(17), pp 5181-5192.
18. Masters, G. M., Ela, W. P. “Introduction to environmental engineering and science”, 2008, Third ed. Prentice-Hall, Inc., Upper Saddle River, N.J.
19. Mathioulakis, E., Belessiotis, V., Delyannis, E., “Desalination by using alternative energy: review and state-of-art,” Desalination, 2007, 203, pp 346-365.
20. Mehanna, M.; Kiely, P. D.; Call, D. F.; Logan, B. E., “A microbial electrodialysis cell for simultaneous water desalination and hydrogen gas production,” Environmental Science & Technology, 2010, 44(24), pp 9578-9583.
21. Mehanna, M.; Saito, T.; Jingling, Y.; Hickner, M. A.; Cao, X.; Huang, X.; Logan, B. E., “Using microbial desalination cells to reduce water salinity prior to reverse osmosis,” Energy & Environmental Science, 2010, 3(8), pp 1114-1120.
22. Menicucci, J.; Beyenal, H.; Marsili, E.; Veluchamy, R. R. A.; Demir, G.; Lewandowski, Z., “Procedure for determining maximum sustainable power generated by microbial fuel cells,” Environmental Science & Technology, 2006, 40(3), pp 1062-1068.
23. Mohanakrishna, G., Venkata Mohan, S., Sarma, P. N., “Bio-electrochemical treatment of distillery wastewater in microbial fuel cell facilitating decolorization and desalination along with power generation,” Journal of Hazardous Materials, 2010, 177(1-3), pp 487-94.
24. Rabaey, K.; Verstraete, W., “Microbial fuel cells: novel biotechnology for energy generation,” Trends Biotechnol., 2005, 23(6), pp 291-298.
25. Raventos, N.; Macpherson, E.; Garcia-Rubies, A., “Effect of brine discharge from a desalination plant on macrobenthic communities in the NW Mediterranean,” Marine Environmental Research, 2006, 62(1), pp 1-14.
26. Rosenbaum, M., He, Z. and Angenent, L. T., “Light energy to bioelectrictiy: photosynthetic microbial fuel cells”, Current Opinion in Biotechnology, 2010, 21(3), pp 259-264.
27. Rozendal, R. A., Hamelers, H. V., Rabaey, K., Keller, J., Buisman, C. J., “Towards practical implementation of bioelectrochemical wastewater treatment,” Trends in Biotechnology, 2008, 26(8), pp 450-9.
28. Rozendal, R. A., Hamelers, H. V. M., Buisman, C. J. N., “Effects of membrane cation transport on pH and microbial fuel cell performance,” Environmental Science and Technology, 2006, 40(17), pp 5206-5211.
29. Schnoor, J. L., “ES&T's Best Papers of 2009,” Environmental Science & Technology, 2010, 44(7), pp 2219-2219.
30. Semiat, R., “Energy issues in desalination processes,” Environmental Science & Technology, 2008, 42(22), pp 8193-201.
31. Shannon, M. A., Bohn, P. W., Elimelech, M., Georgiadis, J. G., Marinas, B. J., Mayes, A. M., “Science and technology for water purification in the coming decades,” Nature, 2008, 452(7185), pp 301-10.
32. Tanaka, Y. “Water dissociation in ion-exchange membrane electrodialysis,” Journal of Membrane Science, 2002, 203(1-2), pp 227-244.
33. Ter Heijne, A., Hamelers, H. V., De Wilde, V., Rozendal, R. A., Buisman, C. J., “A bipolar membrane combined with ferric iron reduction as an efficient cathode system in microbial fuel cells,” Environmental Science & Technology, 2006, 40(17), pp 5200-5.
34. Vrouwenvelder, J. S.; van der Kooij, D., “Diagnosis, prediction and prevention of biofouling of NF and RO membranes,” Desalination, 2001, 139(1-3), pp 65-71.
35. Wang, X., Cheng, S., Feng, Y., Merrill, M. D., Saito, T., Logan, B. E., “Use of carbon mesh anodes and the effect of different pretreatment methods on power production in microbial fuel cells,” Environmental Science & Technology, 2009, 43(17), 6870-6874.
36. U.S. Patent Application Publication No. 2010/0270158 (Ser. No. 12/765,192).

1. A microbial desalination cell, comprising:
an anode at least partially positioned within an anode chamber for containing an aqueous reaction mixture including one or more organic compounds and one or more bacteria for oxidizing the organic compounds;
a cathode that is directly exposed to air;
a saline solution chamber positioned between the anode and the cathode, the saline solution chamber separated from the anode by an anion exchange material and from the cathode by a cation exchange material; and
a cathode rinsing assembly for rinsing the cathode with a catholyte.

2. The microbial desalination cell of claim 1, wherein the anion exchange material at least partially surrounds and defines the anode chamber.

3. The microbial desalination cell of claim 2, wherein at least one of the anode chamber and the saline solution chamber is cylindrical.

4. The microbial desalination cell of claim 2, wherein the anode chamber is at least partially surrounded by the saline solution chamber.

5. The microbial desalination cell of claim 4, wherein the cathode at least partially surrounds the saline solution chamber.

6. The microbial desalination cell of claim 1, wherein the catholyte is acidified water

7. The microbial desalination cell of claim 1, wherein the cathode rinsing assembly comprises at least one sprayer for spraying the catholyte onto the cathode.

8. The microbial desalination cell of claim 1, wherein the cathode rinsing assembly includes a reservoir for collecting the catholyte after it has been used to rinse the cathode.

9. The microbial desalination cell of claim 1, wherein the cathode rinsing assembly includes a control assembly for controlling the pH, the salt concentration or the pH and the salt concentration of the catholyte.

10. The microbial desalination cell of claim 1, wherein the saline solution chamber comprises a fluid inlet positioned on or below a horizontal plane, and a fluid outlet positioned above the horizontal plane, and wherein water flowing between the inlet and outlet flows substantially upwardly.

11. The microbial desalination cell of claim 1, further comprising a control system for selectively adjusting the amount of current and power produced by the microbial desalination cell.

12. A microbial desalination system, comprising a plurality of microbial desalination cells, including at least one microbial desalination cell according to claim 1.

13. A desalination process, comprising:
delivering a saline solution to a saline solution chamber positioned between an anode and a cathode, and separated from the anode by an anion exchange material and from the cathode by a cation exchange material, wherein the cathode is directly exposed to air;
delivering a reaction mixture to the anode chamber, the reaction mixture comprising one or more organic compounds and one or more bacteria for oxidizing the organic compounds, thereby causing electrons to flow from the anode to the cathode; and
rinsing the cathode with a catholyte.

14. The process of claim 13, wherein the catholyte is acidified water.

15. The process of claim 13, wherein rinsing the cathode with the catholyte comprises spraying the catholyte onto the cathode with a sprayer.

16. The process of claim 13, further comprising collecting the catholyte after it has been used to rinse the cathode.

17. The process of claim 16, further comprising recirculating the catholyte.

18. The process of claim 17, further comprising controlling the pH, the salt concentration or the pH and the salt concentration of the catholyte.

19. A microbial desalination cell, comprising:
a saline solution chamber positioned between an anode and a cathode, the saline solution chamber separated from the anode by an anion exchange material and from the cathode by a cation exchange material;
wherein the saline solution chamber comprises a fluid inlet positioned on or below a horizontal plane, and a fluid outlet positioned above the horizontal plane, and wherein water flowing between the inlet and outlet flows substantially upwardly.

20. A microbial desalination system, comprising a plurality of microbial desalination cells, including at least one microbial desalination cell according to claim 19.
